(19) United States
(12) Patent Application Publication
(10) Pub. No.: US 2015/0207189 A1
(43) Pub. Date: Jul. 23, 2015

(54) HEAT EXCHANGE MEMBER OF BATTERY PACK

(71) Applicant: SAMSUNG SDI CO., LTD., Yongin-si (KR)

(72) Inventors: Jeong-Joo LEE, Yongin-si (KR); Tae-Yong KIM, Yongin-si (KR); Young-Deok KIM, Yongin-si (KR)

(21) Appl. No.: 14/601,942

(22) Filed: Jan. 21, 2015

(30) Foreign Application Priority Data
Jan. 22, 2014 (KR) 10-2014-0007565

(51) Int. Cl. H01M 10/6556

(52) U.S. Cl. CPC H01M 10/6556; H01M 2220/30; H01M 2220/20

(57) ABSTRACT

A heat exchange member for a battery pack, the heat exchange member including an upper plate; and a lower plate beneath the upper plate, wherein the upper plate and the lower plate include guide portions on sides thereof that face each other.

### CROSS-REFERENCE TO RELATED APPLICATION

Korean Patent Application No. 10-2014-0007565, filed on Jan. 22, 2014, in the Korean Intellectual Property Office, and entitled: “Heat Exchange Member of Battery Pack,” is incorporated by reference herein in its entirety

### BACKGROUND

1. Field

Embodiments relate to a heat exchange member of a battery pack.

2. Description of the Related Art

Battery cells may be used as energy sources for mobile devices, electric vehicles, hybrid vehicles, or the like. A shape of the battery cell may vary depending on the kind of external device to which the battery cell is applied.

If extended driving and/or high-power driving are required, e.g., in an electric vehicle or hybrid vehicle that consumes a large amount of power, a large-capacity battery module may be configured by electrically connecting a plurality of battery cells in order to increase power and capacity. An output voltage or output current of the battery module may be selected or determined according to a number of battery cells in the battery module. In addition, a battery pack may be configured by electrically connecting such battery modules.

### SUMMARY

Embodiments are directed to a heat exchange member of a battery pack.

The embodiments may be realized by providing a heat exchange member for a battery pack, the heat exchange member including an upper plate; and a lower plate beneath the upper plate, wherein the upper plate and the lower plate include guide portions on sides thereof that face each other.

The guide portions may be along edges of the upper plate and the lower plate.

The lower plate may include flow paths therein, and the guide portions may be on the lower plate and between the flow paths.

The guide portions may include a projection on one of the upper plate and the lower plate, and a groove in the other of the upper plate and the lower plate.

The heat exchange member may further include welding portions on the upper plate and the lower plate, the upper plate and the lower plate being welded to each other at the welding portions through brazing.

The welding portions may be along edges of the upper plate and the lower plate.

Vertical sections of the welding portions at a boundary between the upper plate and the lower plate may include an unevenness structure.

The lower plate may include flow paths therein, and the welding portions may be on the lower plate and between the flow paths.

A tip of the projection may be spaced apart from a bottom of the groove at a predetermined interval.

The predetermined interval may be about 0.1 mm.

### BRIEF DESCRIPTION OF THE DRAWINGS

Features will be apparent to those of skill in the art by describing in detail exemplary embodiments with reference to the attached drawings in which:

FIG. 1 illustrates a perspective view of a heat exchange member of a battery pack according to an embodiment.

FIG. 2 illustrates an exploded perspective view of the heat exchange member of the battery pack according to an embodiment.

FIG. 3 illustrates a sectional view taken along line A-A′ of FIG. 1.

FIG. 4 illustrates an enlarged view showing portion B of FIG. 3.

FIG. 5 illustrates a sectional view of a heat exchange member of a battery pack according to another embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

It will be understood that when an element is referred to as being “between” two elements, it can be the only element between the two elements, or one or more intervening elements may also be present. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween.

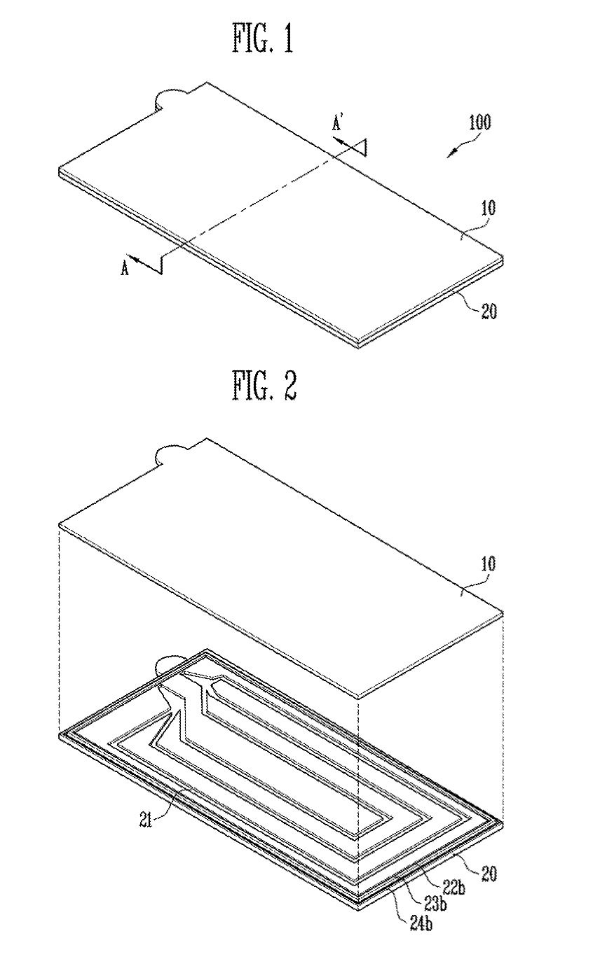

FIG. 1 illustrates a perspective view showing a heat exchange member of a battery pack according to an embodiment. FIG. 2 illustrates an exploded perspective view showing the heat exchange member of the battery pack according to the embodiment.

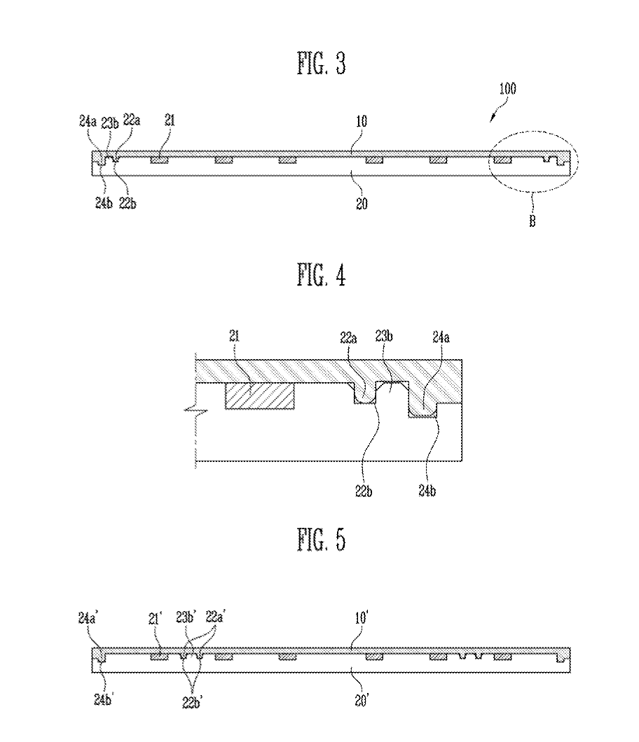

Referring to FIGS. 1 and 2, the heat exchanger or heat exchange member 100 of the battery pack according to the present embodiment may include an upper plate 10 and a lower plate 20. The lower plate 20 may be positioned beneath the upper plate 10, e.g., the lower plate 20 may be aligned with, may underlie, and/or may face the upper plate 10. Guides or guide portions 24a (see FIG. 3) and 24b may be formed in an area of the upper plate 10 and the lower plate 20 where the upper plate 10 and the lower plate 20 face each other. For example, the guide portions 24a and 24b may be formed on respective inner sides of the upper plate 10 and the lower plate 20 such that the guide portions 24a and 24b on the upper plate 10 and the lower plate 20 face each other.

The guide portions 24a and 24b may be respectively formed along edge portions or edges of the upper plate 10 and the lower plate 20. The guide portions 24a and 24b may include a projection portion or projection 24a on (e.g., projecting from) the upper plate 10, and a groove portion or groove 24b (e.g., in the lower plate 20) that is coupled with the projection 24a. In an implementation, the groove 24b may be formed in the upper plate 10 and the projection may be on the lower plate 20. For example, the guide portions 24a and 24b may have a complementary structure in order to facilitate alignment and coupling of the upper plate 10 and the lower plate 20.

The upper plate 10 and the lower plate 20 of the heat exchange member 100 may be fixed to each other by coupling the projection 24a and the groove 24b. For example, the projection 24a (of one of the upper plate 10 or the lower plate 20) may be aligned with and coupled with the groove 24b (of the other of the upper plate 10 or the lower plate 20) such that the upper plate 10 may be easily aligned with the lower plate 20. The upper plate 10 and the lower plate 20 may be welded to each other (e.g., through brazing) in a state in which the upper plate 10 and the lower plate 20 are coupled to each other as described above. Welding portions 22a and 22b (at which the upper plate 10 and the lower plate 20 are welded to each other) may be respectively formed along the edges of the upper plate 10 and the lower plate 20. In an implementation, the welding portions 22a and 22b may be inside or interior to the guide portions 24a and 24b. For example, the welding portions 22a and 22b may have a complementary structure for coupling and welding the upper plate 10 and the lower plate 20.

Brazing is a kind of soldering, and may refer to a method of coupling base materials to each other without melting the base materials by, e.g., penetrating a melted adhesive between the base materials. An adhesive having a melting point lower than that of the base material may be used as an adhesive for brazing.

The upper plate 10 and the lower plate 20 may be manufactured through, e.g., die-casting. For example, die-casting may be a casting method that is a precision casting method including injecting a melted metal into a mold made of steel that is exactly or precisely machined to completely or perfectly correspond to a required or desired casting shape, thereby obtaining a casting equal to or perfectly complementary to the mold.

Brazing surfaces of upper and lower plates may correspond with flat or planar structures or surfaces of the upper and lower plates. Thus, a separate riveting process may be used to align the upper and lower plates. After the riveting is performed, the upper and lower plates may then be welded to each other through brazing, and the portion that is subjected to the riveting may be polished. Accordingly, an extra step may be performed.

According to an embodiment, the guide portions 24a and 24b may help align and/or fix positions of the upper plate 10 and the lower plate 20 (e.g., without the need for a separate riveting step), thereby improving assembly efficiency. For example, a press-fit structure between the upper plate 10 and the lower plate 20 may be formed by the guide portions 24a and 24b, so that it is possible to increase mechanical strength against high-pressure, vibration, and/or impact.

As described above, according to an embodiment, a riveting process for fixing the upper plate 10 and the lower plate 20 may be omitted, and thus a process of polishing a riveting shape that may protrude after the upper and lower plates 10 and 20 are welded to each other through the brazing may also be omitted. Further, the guide portions 24a and 24b may help ensure strong mechanical strength of the heat exchange member 100, even if the heat exchange member 100 has a low height or thickness and/or a narrow width or length.

Hereinafter, although not shown in these figures, a battery module having the heat exchange member 100 mounted thereto or included therein will be briefly described.

The battery module may have a structure in which a plurality of battery cells are arranged in one direction. Each battery cell may include a cap plate having terminals on an upper surface thereof. In addition, each battery cell may have a bottom surface that is opposite to the cap plate. In an implementation, the heat exchange member may be provided on the bottom surface of each battery cell.

Each battery cell may include a case having one open side. An electrode assembly and an electrolyte may be accommodated in the case. The electrode assembly and the electrolyte may generate energy through an electrochemical reaction therebetween, and the case (e.g., the open side of the case) may be sealed by the cap plate. The cap plate may include the terminals and a vent. The terminals may include positive and negative electrode terminals having different polarities from each other. The vent may be a safety device of the battery cell, which may act as a passage through which gas generated inside the battery cell is exhausted to an outside of the battery cell. Positive and negative electrode terminals of adjacent battery cells may be electrically connected to each other through a bus-bar. The bus-bar may be fixed to the positive and negative electrode terminals by a member, e.g., a nut.

The battery module may include a plurality of the battery cells aligned in one direction. In an implementation, one or more plates may be used to fix an alignment state of the battery cells. The plate may fix the plurality of battery cells, and may be variously modified according to the design of the battery module.

FIG. 3 illustrates a sectional view taken along line A-A′ of FIG. 1.

Referring to FIG. 3, the heat exchange member 100 of the battery pack according to the present embodiment may include the upper plate 10 and the lower plate 20. The guide portions 24a and 24b may be respectively formed along the edges of the upper plate 10 and the lower plate 20. The guide portions 24a and 24b may guide or align positions of the upper plate 10 and the lower plate 20 (e.g., during coupling or joining of the upper plate 10 and the lower plate 20) by coupling the projection 24a (e.g., on the upper plate 10) and the groove 24b (e.g., in the lower plate 20).

The upper plate 10 and the lower plate 20 may be welded to each other through, e.g., brazing, in the state in which the upper plate 10 and the lower plate 20 are fixed to each other by the guide portions 24a and 24b. In an implementation, vertical sections of the welding portions 22a and 22b, e.g., surfaces of the welding portions 22a and 22b that are perpendicular or orthogonal to a plane of the upper plate 10 and lower plate 20, at the boundary or interface between the upper and lower plates 10 and 20 may have unevenness shape or structure. For example, the unevenness shape or structure may be a roughened, corrugated, or otherwise increased surface area structure. The welding portions 22a and 22b may be respectively formed along edges of the upper plate 10 and the lower plate 20 at a region inside the guide portions 24a and 24b, e.g., toward an interior of the upper plate 10 and the lower plate 20 relative to the guide portions 24a and 24b. For example, the welding portions 22a and 22b may have the unevenness or increased surface area structure, so that a sufficient area welded through, e.g., the brazing, may be ensured, thereby improving the mechanical strength of the heat exchange member 100.

The heat exchange member 100 may have a plate shape and may have a predetermined thickness. The heat exchange member 100 may be used to control heat of the battery cell, e.g., may disperse heat from the battery cell. A flow path 21 (through which a heat exchange medium may flow to exchange heat with the battery module, e.g., the battery cells) may be provided inside the heat exchange member 100.

In the heat exchange member 100, the upper plate 10 may be positioned on the lower plate 20 (having the flow path 21 formed therein). In this case, the vertical sections of the welding portions 22a and 22b may have the unevenness or increased surface area structure, so that the flow path 21 in the heat exchange member 100 may be more surely sealed from the outside. For example, it is possible to help prevent leakage of the heat exchange medium that moves through the flow path 21.

FIG. 4 illustrates an enlarged view showing portion B of FIG. 3.

Referring to FIG. 4, the sections of the welding portions 22a and 22b (welded to each other through, e.g., the brazing, after the positions of the upper plate 10 and the lower plate 20 of the heat exchange member 100 are fixed to or aligned with each other) may be provided with the unevenness or increased surface area structure. For example, such a structure may help increase a contact area between the upper plate 10 and the lower plate 20 at the welding portions 22a and 22b of the upper plate 10 and the lower plate 20, thereby improving the mechanical strength of the heat exchange member 100.

The upper plate 10 and the lower plate 20, where the respective guide portions 24a and 24b are positioned, may be spaced apart from each other at a predetermined interval or distance. For example, a tip (e.g., a lowermost tip) of the projection 24a may be spaced apart from a bottom of the groove 24b, as illustrated in FIG. 4. In an implementation, the upper plate 10 and the lower plate 20, where the respective guide portions 24a and 24b are positioned, e.g., at the tip of the projection 24a and the bottom of the groove 24b, may be spaced apart from each other at an interval of about 0.1 mm. For example, the welding portions 22a and 22b may be formed into a structure in which the welding portions 22a and 22b respectively contact with contact surfaces of the upper plate 10 and the lower plate 20. For example, the welding portions 22a and 22b may closely contact each other or may be pressed into each other in order to form a seal between the upper plate 10 and the lower plate 20.

A press-fit portion 23b may be formed between the guide portions 24a and 24b and the welding portions 22a and 22b, and it is possible to more easily align positions of the upper plate 10 and the lower plate 20. The guide portions 24a and 24b, the welding portions 22a and 22b, and the press-fit portion 23b may be formed as described above, and it is possible to help prevent leakage of the heat exchange medium moving through the flow path 21.

FIG. 5 illustrates a sectional view showing a heat exchange member of a battery pack according to another embodiment.

Referring to FIG. 5, the heat exchange member of the battery pack according to the present embodiment may include an upper plate 10′ and a lower plate 20′ (positioned beneath the upper plate 10′). In addition, guide portions 24a′ and 24b′ may be formed in an area of the upper plate 10′ and the lower plate 20′ where the upper plate 10′ and the lower plate 20′ face each other, e.g., on inner surfaces of the upper plate 10′ and the lower plate 20′.

The guide portions 24a′ and 24b′ may be respectively formed along edges of the upper plate 10′ and the lower plate 20′. The guide portions 24a′ and 24b′ may include a projection 24a′ (formed on or projecting from the upper plate 10′), and a groove 24b′ in the lower plate 20′ that is coupleable with (e.g., complementary to) the projection 24a′.

The upper plate 10′ and the lower plate 20′ of the heat exchange member may be welded to each other (e.g., through brazing) in a state in which the upper plate 10′ and the lower plate 20′ are fixed to each other through the coupling between the projection 24a′ and the groove 24b′. For example, welding portions 22a′ and 22b′ (e.g., portions at which the upper plate 10′ and the lower plate 20′ are welded to each other) may be formed in an area of the lower plate 20′ that is between flow paths 21′ in the lower plate 20′. For example, the welding portions 22a′ and 22b′ may be formed by using a space in which the flow path 21′ is not formed.

By way of summation and review, a high-power and large-capacity battery pack may generate a large amount of heat in a charging/discharging process thereof. It may be desirable for a battery pack to easily dissipate heat generated in each battery cell. For example, a heat exchange member or heat exchanger may be mounted in the high-power and high-capacity battery pack.

The embodiments may provide a heat exchange member for a battery pack, which heat exchange member may be easily assembled.

The embodiments may provide a heat exchange member of a battery pack, in which guide portions are formed in the heat exchange member to fix positions of upper and lower plates before assembling of the heat exchange member, thereby facilitating assembly of the heat exchange member. Accordingly, assembly efficiency may be improved.

The embodiments may provide a heat exchange member of a battery pack, in which an area where upper and lower plates of the heat exchange member are welded to each other (e.g., through brazing) may be increased, thereby improving the mechanical strength of the heat exchange member. Accordingly, it is possible to help prevent a heat exchange medium from leaking from the flow path of the heat exchange member.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A heat exchange member for a battery pack, the heat exchange member comprising:
an upper plate; and
a lower plate beneath the upper plate,
wherein the upper plate and the lower plate include guide portions on sides thereof that face each other.

2. The heat exchange member as claimed in claim 1, wherein the guide portions are along edges of the upper plate and the lower plate.

3. The heat exchange member as claimed in claim 1, wherein:
the lower plate includes flow paths therein, and
the guide portions are on the lower plate and between the flow paths.

4. The heat exchange member as claimed in claim 1, wherein the guide portions include:
a projection on one of the upper plate and the lower plate, and
a groove in the other of the upper plate and the lower plate.

5. The heat exchange member as claimed in claim 1, further comprising welding portions on the upper plate and the lower plate, the upper plate and the lower plate being welded to each other at the welding portions through brazing.

6. The heat exchange member as claimed in claim 5, wherein the welding portions are along edges of the upper plate and the lower plate.

7. The heat exchange member as claimed in claim 5, wherein vertical sections of the welding portions at a boundary between the upper plate and the lower plate include an unevenness structure.

8. The heat exchange member as claimed in claim 5, wherein:
the lower plate includes flow paths therein, and
the welding portions are on the lower plate and between the flow paths.

9. The heat exchange member as claimed in claim 4, wherein a tip of the projection is spaced apart from a bottom of the groove at a predetermined interval.

10. The heat exchange member as claimed in claim 9, wherein the predetermined interval is about 0.1 mm.
